(19) United States
(12) Patent Application Publication
(10) Pub. No.: US 2014/0161517 A1
(43) Pub. Date: Jun. 12, 2014

(54) Failed furniture cyclinder height adjustment replacement device

(71) Applicant: Timothy Lee Lockwood, Rescue, CA (US)

(72) Inventor: Timothy Lee Lockwood, Rescue, CA (US)

(21) Appl. No.: 13/694,514

(22) Filed: Dec. 6, 2012

(51) Int. Cl. F16B 7/04

(52) U.S. Cl. CPC F16B 7/0406
USPC 403/364

(57) ABSTRACT

A device to be used singly or in plurality for adjusting and maintaining the height of a failed adjustable cylinder used in furniture is provided. The device is a flexible elongated generally “C-shaped” in cross section member sized with an interior diameter slightly smaller than the diameter of an adjustable height furniture cylinder cylindrical perimeter. The device(s) are sufficiently resilient that they can be flexed to allow the cylinder to pass into and reside within the interior region thereof. The devices are preferably ribbed on the inside surface, and are made to releaseably interlock when used plurally. A interlocking connection may be employed The devices thus adjust and maintain the desired height of the furniture utilizing an adjustable height cylinder.

### RELATION TO OTHER PATENT APPLICATIONS

This application is a continuation in part of my application Ser. No. 13/115,110 Filed on May 25, 2011, now ______.

### FIELD OF INVENTION

The following invention relates to the use of one or more removable clamp type spacers—units—for fixedly maintaining the height of furniture, usually chairs, but possibly tables, that use an adjustable gas cylinder for height adjustment when the gas cylinder has failed or become non-operative

### CROSS-REFERENCE TO RELATED APPLICATIONS

Not Applicable

### BACKGROUND OF THE INVENTION

A variety of different situations exist where a need is presented for adjusting and maintaining the proper height of furniture, such as a chair or work surface, that utilizes an adjustable gas cylinder to set the elevation of the work surface or seat of a chair. For instance, the adjustable cylinder may fail to support the weight of the occupant, may not consistently maintain the correct ergonomic height, or may fail over time as gas or fluid leaks from the cylinder. As a result of failure of the cylinder, the work surface or seating surface will fall to the lowest possible elevation.

Conventional 2 piece clamps that are joined with a fastener to provide a clamping force are not convenient to install and also require the use of tools. U.S. patent application Ser. No. 10/400,495 to Hamilton (2003) shows a 2 piece clamp placed around a cylinder and secured with screws. Additionally, such clamps have a tendency to score the metal of the adjustable cylinder they are attached to. If the cylinder is lubricated, as in the case of most adjustable cylinders used for a chair, the conventional clamp will slide and not hold in place.

Concave channels are also “C-shaped” in cross section and are used to hold cylindrical element in place. U.S. Pat. No. 4,903,629 to Mauldin (1990) is utilized to maintain a boat cover in place. While having spaced opposed arcuate sections, this device which features a closeable jaw, as seen in FIGS. 2A and 2B is not suitable for the intended purpose of this invention. U.S. Pat. No. 7,144,209 to Komine (2006) is used to cover up a slot or home formed in a machine tool. Clearly the shape of the Komine device renders it not suitable for the intended purpose of fitting on a round shaft or tube. While somewhat similar in shape, neither may be used in a manner to maintain the height of a failed, aka non-operative adjustable cylinder.

Another class of connectors utilize an elongate clamp having a “C-shaped” cross-section and is formed of a resilient material allowing the clamp to open and close somewhat. An interior region of the clamp is sized to conform to a size of cylindrical frame element. For instance, U.S. Pat. No. 4,759,518 to Yardas (1988) show a trash bag support system which requires specialized frame elements. U.S. Pat. No. 5,752,297 to Ramey (1998), appears at first glance to be quite related to the shape of applicant's device. This patent is titled Method and Apparatus for securing flexible sheeting, to a cylindrical structure. As will be demonstrated, there are significant differences between the structure of Ramey and the current invention, not only as to use but as to properties as well. Another known older reference known to applicant is U.S. Pat. No. 1,362,651 to Towns (1919), which, while having a spaced pair of opposed arcuate sections, a bead pair or bent back section 16 prevents easy access to the space between the arcuate sections. Indeed there are many more references that can be cited both by applicant and an Examiner that include spaced opposed arcuate jaws. Neither any of the recited prior art patents, nor other references known to applicant but not listed, are of the nature of the devices of this invention, nor are they used for maintaining the height of an adjustable cylinder.

While many different methods exist for replacing a failed adjustable cylinder, all at great expense, there are no methods that allow for a tool free installation to adjust and maintain the proper height of a chair or work surface without removing the failed adjustable cylinder. Accordingly, a need exists for a system which is useable to readily adjust a furniture cylinder to maintain a desired height, with the system being readily removable when the pre-determined and maintained height is no longer needed. This allows the user to reconfigure the elevation as may be needed.

### SUMMARY OF THE INVENTION

A device which can be used in the plurality to raise the elevation of a work surface of a table or a seating surface (the seat of a chair) whose elevation was previously adjustable by the operation of an adjustable gas cylinder but which cylinder is currently non-operable. Each device comprises an interrupted circular member having opposed forward extending tips at the two ends of the interrupted circular member.

There are three embodiments of this invention. In the first embodiment, the thin side edges of the interrupted circular member are smooth. in the second version, the thin side edges have the flat surface of each device knurled in (A) and (B) patterns on opposite side edges of the interrupted circular member to aide in the interconnection of two or more units, wherein an (A) knurling pattern of unit #1 would engage the (B) knurling pattern of unit #2, such that when placed on the cylinder chamber of the item to be raised, the plurality of devices would be interlocked. A third and less preferred version uses as its mode of securing interlock capability, a coating as by brushing or spraying a tackifier containing coating on the side edges of each unit, to prevent rotation of any individual unit.

It is a first object therefore to provide a clamping system of one or more inventive units to maintain the height for furniture utilizing adjustable cylinders.

It is a second object to provide a height adjustment system in a manner which is easily attachable, fixedly adjustable and detachable.

It is a third object to provide a height adjustment system, that can be utilized on commonly available furniture adjustable cylinders.

It is a fourth object to provide to provide a height retention system for furniture whose height is controlled by the actuation of a non-operable gas cylinder.

It is a fifth object to provide a device which exhibits sufficient flexibility to allow the device(s) to snap onto a furniture adjustable cylinder and sufficient rigidity to require more force to remove the device(s) from the cylinder than would typically be applied thereto by a person sitting or leaning on the furniture.

It is a sixth object to provide a device to adjust and maintain a consistent height for furniture utilizing adjustable cylinders for height adjustment, when the cylinder is not functioning.

Further objects of this invention will become apparent from a careful reading of the detailed description provided herein as well as from review of the drawings

### BRIEF DESCRIPTION OF THE FIGURES

FIG. 1 is a perspective view of the first embodiment of a device of this invention disposed upon an adjustable cylinder element. Draftsman—2B modified as to tips

FIG. 2 is a sectional view of a device of this invention and the adjustable cylinder element of an office chair for example, during the process of placing the device over the adjustable cylinder to form the connection seen in FIG. 1. Draftsman—modify the tips

FIG. 3 is a sectional view of all embodiments of the device. Draftsman old FIG. 3 tips 2B modified

FIG. 4 is a top view of the first embodiment of this invention showing the smooth top side edge with no knurling.

FIG. 5 is a bottom edge of the second embodiment of the invention showing the (B) knurling.

FIG. 6 is a closeup exploded view showing two of the devices of this invention at a moment time just prior to the engagement of the (B) knurling of the lower device, with the (A) knurling of the upper device on a tube.

FIG. 7 is a rear edge view of the second embodiment of this invention showing a tackifier layer on the upper and lower surfaces of the device instead of the knurling.

FIG. 8 is an elevational view of a pair of the devices disposed upon a chair's height adjusting cylinders.

### DETAILED DESCRIPTION OF THE PREFERRED EMBODIMENT

With Reference to the drawings, wherein like reference numerals represent like parts throughout the various drawing figures, reference numeral 10 is directed to a device for maintaining the height of the adjustable cylinder element 60.

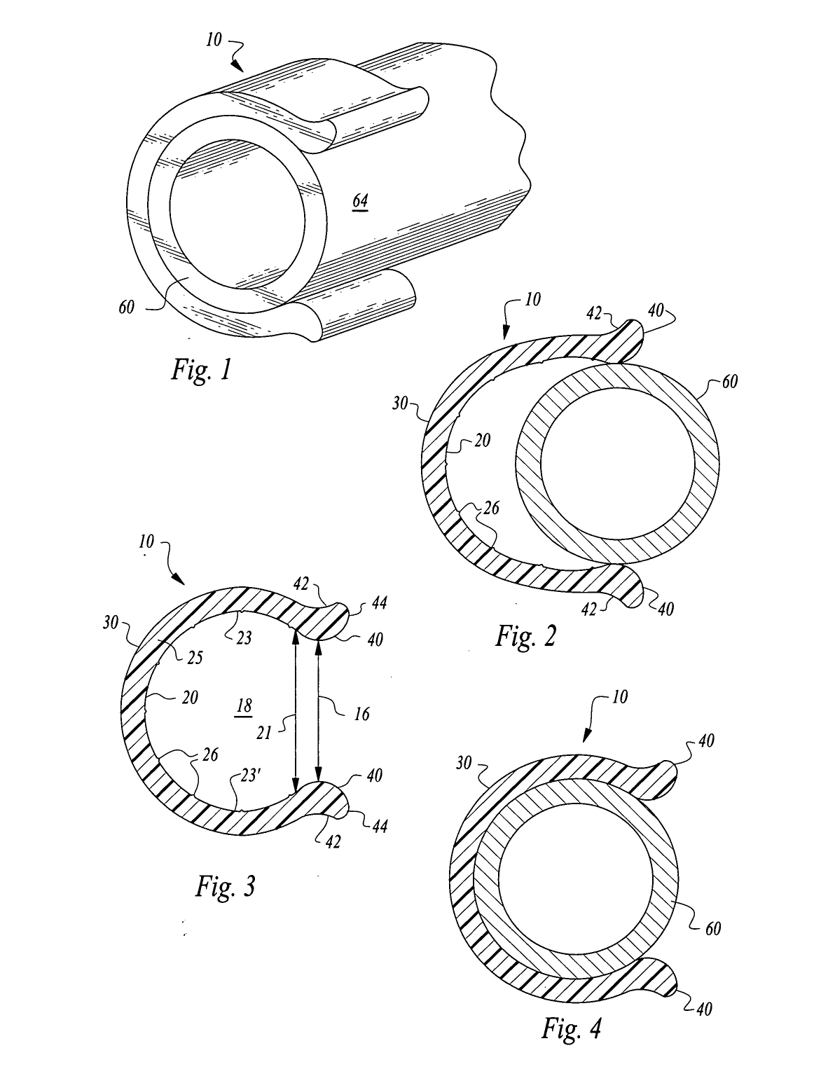

In FIGS. 1-4, the device 10 is seen to be an interrupted circle having a pair of opposed forwardly extending tips 40 to be described in more detail below. Stated another way, the device is a generally “C-shaped” member in cross section having a gap 16 leading into an interior 18. The interior 18 of device 10 is generally cylindrical and has a diameter which is sized to matingly receive a diameter of the cylindrical surface 64 of the adjustable cylinder element 60.

These adjustable cylinders such as found on the Aeron Chair by Herman Miller among others, disposed in a vertical orientation, permits the seat surface to be elevated from about 16 inches from the ground to about 20.5 inches from the ground. Other manufacturers of chairs with adjustable cylinder height controls include, Hon and Steelcase.

In FIGS. 1-4 the device of this invention is seen generally, without reference to any embodiment 1, 2 or 3. That is, the edge treatment that defines the differences between the embodiments is only seen in FIG. 1, which is the first embodiment, and neither the top side edge nor the bottom side edge is seen in FIGS. 2-4 and which will be discussed in detail infra.

The device 10 is defined around the interior 18 by the inner surface 20 and also includes an outer surface 30 parallel to and spaced from the inner surface 20. The device has 2 tips 40 defining the edges of the gap 16. The tips 40 extend away from the gap 16 to tips 44 allowing the device 10 to more easily pass around the cylindrical adjustable cylinder element 60. It has been now found that a bulbous tip of a slightly wider cross section than the rest of the device is easier to grasp to spread the device apart for removal from on the cylinder, and is easier to push inwardly to ensure a secure fit on the cylinder exterior. This is in contrast to the lips of the device of Ramey U.S. Pat. No. 5,752,297 wherein the lips extend outwardly and have a pointed end. The bulbous tips of this invention serve to keep each device from mechanically failing, and sliding over one another when a plurality of devices are employed.

One tip 40 is provided at each side of the gap 16 so that each side of the throat 21 has a tip 40 attached thereto. Each tip 40 has a virtual base 42 where the tip 40 attaches to the cylindrical portion of the device 10. The term virtual is used as the tips are integrally formed at the same time as the balance of the device.

The device 10 is a slightly flexible construct having a uniform “C-shaped” configuration along its entire length but for the tips. The device 10 includes a first end 12 spaced from a second end 14. The device 10 has a gap 16 on one side thereof which leads into an interior region 18 of the device 10.

The interior region 18 of device 10, rearwardly of the two spaced tips 40, is defined by the inner surface 20 which is an interrupted circle having a throat opening of a first dimension. The location of the gap 16 between the two closest points of the tips 40 is of a second slightly smaller dimension. The inner surface 20 of this C-shaped device thus has a throat portion 21 adjacent gap 16 and a maximum diameter between designators 23 and 23′.

Because the inner surface 20 of this C-shaped unit has a diameter between points 23 and 23′ that is slightly smaller than the diameter of the cylinder used in 95% of all adjustable cylinder operated chairs in the USA, which is about 1.10 inches, the adjustable cylinder element 60 can be trapped within the interior 18 of the device 10 for a mating engagement. wherein the device 10 is secured to the adjustable cylinder element 60. Note that the inner surface 20 actually has a diameter which is slightly less than the adjustable cylinder element 60, so that the device 10 remains expanded somewhat at all times when the adjustable cylinder element 60 is located therein.

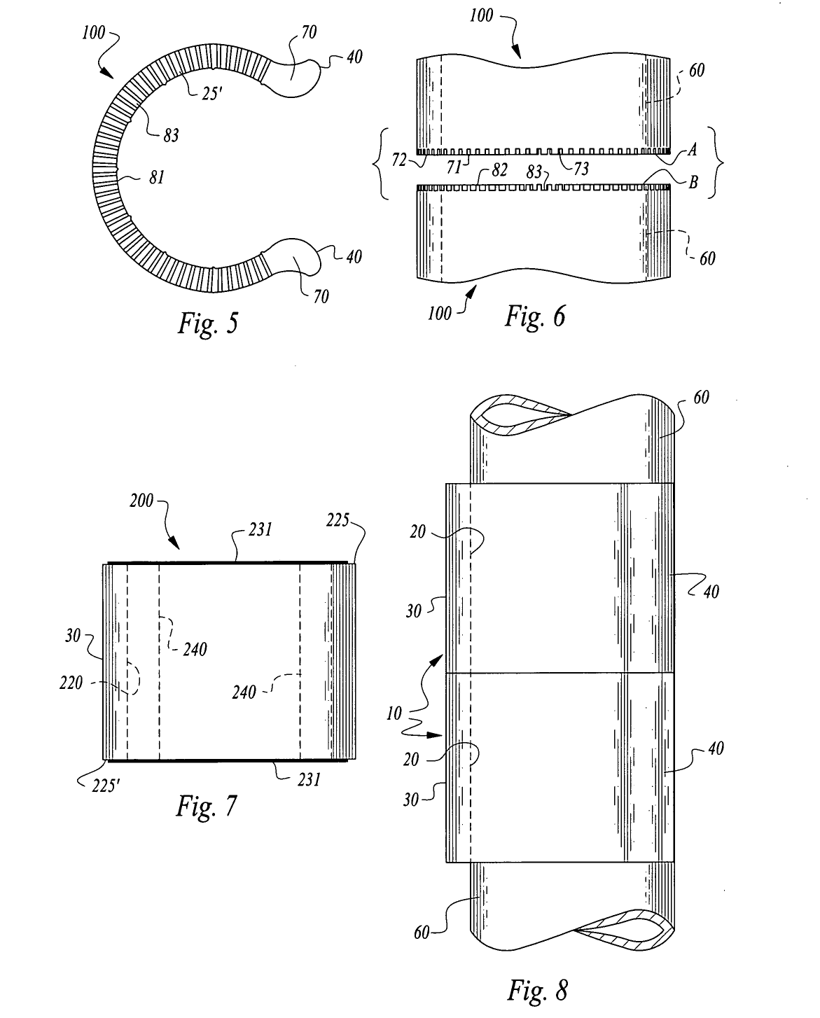

The inner surface 20 of the device 10 for all of the embodiments, is preferably provided with a series of ribs 26 which extend away from the inner surface 20 and toward the center of the interior 18 of the device 10. The ribs 26 preferably have a height of only 0.01 inches and are barely visible when device 10 is securely fastened to adjustable cylinder 60. The top and bottom side edges are designated 25 and 25″ respectively with 25′ now seen in FIG. 5. The ribs may be any of square, or hemispherical or triangular as may be desired or are easier to mold. The function of the ribs in this invention is totally contrary to the purpose of Ramey's ribs. Whereas in Ramey, the ribs are employed to better grip the shade fabric material. Here the ribs serve to REDUCE the overall friction of the interior surface of the device against the upstanding tube of the furniture unit (chair). The friction is reduced by lowering the surface area of the device in actual contact with the tube of the furniture. The reduced friction serves to facilitate the raising or lowering of the device on the tube of the furniture after initial placement on the tube as one slides the unit(s) up and down to determine the desired height of the seating surface or work surface as the case may be while holding the seat surface at the highest elevation manually possible, and then letting go, such that the height is determined by the unit(s) placed.

Expansion of the device 10 is further enhanced slightly by the height of the ribs 26. Thus a slight friction fit is provided between device 10 and adjustable cylinder element 60 to prevent the device from sliding along the long axis thereof out of its desired position. The ribs 26 are preferably substantially triangular in configuration so that they have a point that provides enough friction to maintain position, but not prevent device 10 from being moved into position. The spaced ribs may be present along all or part of interior surface 20 as may be desired.

The device 10 is preferably formed from a material which exhibits an optimum amount of both elasticity and rigidity, such as PVC (polyvinyl chloride) or ABS (acrylonitrile-butadiene-styrene) by either injection molding or extrusion of polymer resin. Specifically, the device 10 is sufficiently flexible and elastic that the throat 21 of the inner surface 20 can be flexed open to a width which matches a width of the extreme 23 of the inner surface 20 without undergoing plastic deformation or other permanent damage to the device 10. The device 10 must be sufficiently resilient and elastic that the throat 21 will return to its original position once the adjustable cylinder element 60 is located entirely within the interior 18 or has been removed away from the device in case the device is to be re-used on another chair or table.

For ease and convenience of the user, the device 10 can preferably range in elevation from 0.5 to 2.0 inches in elevation in ½ inch increments. Though longer and shorter units of the device are also contemplated down to ¼ inch and up to 10 inches.

In FIG. 4 the device of FIG. 1 is seen in full engagement with the tube 60. Since the ribs are of such a small elevation relatively speaking, they can not be readily seen.

In FIG. 5, the bottom edge knurling pattern (B) of the first embodiment is seen on a device designated 100. Commencing just rearwardly of each tip 40 is an alternating series of ribs 81 having an elevation 82, and flat valleys 83, from one tip 40 to the other tip 40. See also FIG. 6.

In FIG. 6, the top edge knurling pattern (A) of the first embodiment is seen on a device designated 100. Commencing just rearwardly of the tips 40, there is seen an extended flat space 70, followed by a series of alternating, upstanding ridges 71 having an elevation 72 and flat valleys 73

In FIG. 6, the mating engagement of a pair of the devices 100 of this invention is seen wherein the (A) knurling ridges engage the valleys of the (B) knurling and (B) knurling ridges engage the valleys of the (A) knurling. This engagement forms an interlocking bond between the two units between the edges 25 of one unit and 25′ of the other unit. Either unit can be of the same or different elevation, which is defined as the distance between the top side edge and the bottom side edge, as may be desired.

FIG. 7 is a rear elevational view of the second embodiment of this invention designated 200. Here the outer surface 30 is seen, along with the two tips 240, while the inner surface 220 is not seen in this view. A coating 231 over lays the two side edges 225 and 225′. The coating 231 is an adhesive that contains a tackifier. Tackifiers are chemical compounds used in adhesives to increase the tack or stickiness of the surface of the adhesive coating. However the degree of tack should be such that while two adjacent units can stick together, they can be easily pulled apart by an adult human. Much like a Post-it brand note. Thus both of the means for providing an interlock when the devices are used plurally, provide easily releasable engagement.

It is readily seen that by adjusting the thickness—the distance between point 30 and point 20 of the device as in FIG. 3, the flexibility of the device can be increased or decreased thus affecting the ease of placement and removal from the height adjusting cylinder of the furniture item. A preferred thickness is between 1/16th and ⅕th inch thick. Thus, the devices 10, 100, and 200 must exhibit sufficient rigidity that the throat 21 cannot be too easily opened and closed, but rather so that the device(s) will securely hold the adjustable cylinder element 60 within the interior 18 of the device(s) unless an intended, non-incidental force is applied to remove the adjustable cylinder element 60 out of the interior 18 of the device(s

For adjustable cylinder element 60 having different diameters and for applications where a greater or lesser amount of force is desired for attachment or detachment of the devices 10,100,200 to the adjustable cylinder element 60, the dimensions would be altered accordingly to provide the desired design characteristics.

From the description above a number of advantages of my adjustable cylinder furniture device become evident:

1. No tools are needed for the installation or removal of one or more of the devices of either embodiment of this invention.

2. Unskilled labor and little brother or big sister can carry out the installation and removal of these devices at home at the office and in the college dorm.

3. The devices of this invention serve the need of overweight folks, as certain cylinders have a weight limit capacity for height retention. This limit can be overcome by the installation of the devices of this invention.

4. As personnel change in an office, any chair or table with a broken cylinder can still be adapted to the new employee's height needs by the addition or subtraction of one or more of these devices, thus extending furniture life cycles.

Since certain changes may be made in the above described apparatus without departing from the scope of the invention herein involved, it is intended that all matter contained in the above description and in the accompanying drawings, if present, shall be interpreted as illustrative only and not in a limiting sense

I claim:

1. A device to be used singly or in plurality for adjusting and maintaining the height of a failed adjustable cylinder used in furniture such as chairs or tables for determining the height of the work or seat surface, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom side edges each having a releaseably engageable means thereon, to assist in the engagement of one of said devices to another of said devices when they used in the plurality.

2. The device of claim 1 wherein the releasable engagement means comprises knurling on each of the top and bottom edges, wherein one edge has a (A) knurling pattern and the other edge has a (B) knurling pattern, the (A) pattern and the (B) pattern being engageable.

3. The device of claim 1 wherein the interior surface has a series of spaced ribs thereon, over at least a portion of said interior surface.

4. The device of claim 1 wherein the releasable engagement means comprises a tackified adhesive coating on the top and bottom edges of said device.

5. The device of claim 4 wherein the interior surface has a series of spaced ribs thereon, over at least a portion of said interior surface.

6. The device of claim 1 wherein the device is made of a flexible polymer in finite lengths that vary between ¼ and 10 inches.

7. A device to be used singly or in plurality for adjusting and maintaining the height of a failed adjustable cylinder used in furniture such as chairs or tables for determining the height of the work or seat surface, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom edges each having a releaseably engageable means thereon, to assist in the engagement of one of said devices to another of said devices when they used in the plurality,
wherein the interior surface has a series of spaced ribs thereon, over at least a portion of said interior surface, and
wherein the releasable engagement means comprises knurling on each of the top and bottom edges, wherein one edge has a (A) knurling pattern and the other end has a (B) knurling pattern, the (A) pattern and the (B) pattern being engageable.

8. A device to be used singly or in plurality for adjusting and maintaining the height of a failed adjustable cylinder used in furniture such as chairs or tables for determining the height of the work or seat surface, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom side edges each having a releaseably engageable means thereon, to assist in the engagement of one of said devices to another of said devices when they used in the plurality,
wherein the interior surface has a series of spaced ribs thereon, over at least a portion of said interior surface, and
wherein the releasable engagement means comprises a tackified adhesive coating on the top and bottom edges of said device.

9. In combination, (a) a furniture item having a non-operative elongated adjustable cylinder for adjusting and maintaining the height of the furniture item, and
(b) at least one device for adjusting and maintaining the height of a non-operative adjustable cylinder used in a furniture item for determining the height of a work or seat surface, disposed on said cylinder to retain the height of the work or seat surface at a fixed elevation, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom edges each having a releaseably engageable means thereon, to assist in the engagement of one of said devices to another of said devices when they used in the plurality,
wherein the interior surface has a series of spaced ribs thereon, over at least a portion of said interior surface, and
wherein the releasable engagement means comprises knurling on each of the top and bottom edges, wherein one edge has a (A) knurling pattern and the other edge has a (B) knurling pattern, the (A) pattern and the (B) pattern being engageable.

10. The combination of claim 9 wherein the releasble engagement means is replaced by a layer of tackified adhesive on the upper and lower edged of said device.

11. A device to be used singly or in plurality for adjusting and maintaining the height of a failed adjustable cylinder used in furniture such as chairs or tables for determining the height of the work or seat surface, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom side edges each having a smooth surface thereon.

12. The device of claim 11 wherein the interior surface has a series of spaced ribs thereon, over at least a portion of said interior surface.

13. In combination, (a) a furniture item having a non-operative elongated adjustable cylinder for adjusting and maintaining the height of the furniture item, and
(b) at least one device for adjusting and maintaining the height of a non-operative adjustable cylinder used in a furniture item for determining the height of a work or seat surface, disposed on said cylinder to retain the height of the work or seat surface at a fixed elevation, which device comprises:
an elongated generally C-shaped in cross-section member having a width, top and bottom edges, and interior and exterior surfaces, and a pair of tips of a bulbous configuration, one disposed at each end of the C-shaped member and a finite length,
the top and bottom side edges each having a smooth surface and wherein the interior surface has a series of spaced ribs thereon, over at least a portion of said interior surface.
